(19) United States
(12) Patent Application Publication
(10) Pub. No.: US 2023/0042394 A1
(43) Pub. Date: Feb. 9, 2023

(54) Read-Only Caching Network File System

(71) Applicant: Bank of America Corporation, Charlotte, NC (US)

(72) Inventor: Bruce Badger, London (GB)

(21) Appl. No.: 17/392,444

(22) Filed: Aug. 3, 2021

(51) Int. Cl. H04L 29/08

(52) U.S. Cl. CPC H04L 67/06; H04L 67/2847; H04L 67/2852

(57) ABSTRACT

A reactive, WebDAV-based, read-only, caching, file system provides immutable read-only files from a WebDAV server to a client in response to on-demand client file requests or, if the file was previously cached, from a cache server to the client. Files are cached on the cache server in response to previous on-demand client file requests or for client searches performed on directories containing the files. By restricting the file system to read-only files, requiring immutability (i.e., prohibiting file changes), and only providing files in response to on-demand pull requests, a WebDAV architecture can be dramatically optimized.

### TECHNICAL FIELD OF DISCLOSURE

The present disclosure relates to processes and machines for network file systems as well as new and useful improvements thereof including, but not limited to, improved WebDAV systems, methods, and apparatus for managing, distributing, and caching read-only immutable files on servers and providing on-demand remote client access to the same.

### BACKGROUND

Web Distributed Authoring and Versioning (WebDAV) is an extension of the Hypertext Transfer Protocol (HTTP) that allows clients to perform remote web content authoring operations and extends the set of standard HTTP verbs and headers allowed for request methods. WebDAV is defined in the industry standard RFC 4918 and HTTP caching is defined in RTC 7234. The WebDAV protocol provides a framework for users to create, change and move documents on a server. Important features of the WebDAV protocol include the maintenance of properties about an author or modification date, namespace management, collections, and overwrite protection. Maintenance of properties includes such things as the creation, removal, and querying of file information. Namespace management deals with the ability to copy and move web content within a server's namespace. Collections deal with the grouping of sets of files and other collections. Web content may be created, removed, and listed. Lastly, overwrite protection handles aspects related to locking of files. Many modern operating systems provide built-in client-side support for WebDAV.

Current content distribution mechanisms basically use “push” methods in which content is copied from a central repository to each host, intermediate server, and/or client. In such cases, all content which might be needed may essentially be copied everywhere. This is despite the fact that only a small percentage of the content that was copied or moved around networks and stored was actually used; hence, it was of no benefit whatsoever. This is processor intensive, results in high latency, unnecessarily consumes large amounts of bandwidth, and wastes valuable network resources.

Improved systems, methods, and apparatus for managing and distributing files on servers and providing remote client access to the same are needed.

### SUMMARY

Aspects of this disclosure address one or more of the shortcomings in the industry by, inter alia, implementing a reactive (i.e., only on-demand or pull-only), WebDAV-based, read-only, caching, file system that provides immutable read-only files from a WebDAV server to a client. Files are provided reactively, not proactively, and are transferred by servers in response to on-demand client file requests or, if the file was previously cached, transferred from cache servers to clients. Files can be cached on cache servers in response to prior on-demand client file requests. By restricting the file system to read-only files, requiring immutability (i.e., prohibiting file changes), and only providing files in response to on-demand (i.e., “pull”) requests, the inventions of this disclosure provide a substantially optimized WebDAV architecture that dramatically decreases latency, bandwidth consumption, processor utilization, and use of network resources. The intention is that all content is served reactively on demand, not proactively or in response to a PROPFIND command. However, cache warming as described herein can be implemented as part of one or more aspects of this disclosure.

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions of this application are disclosed in the specification throughout this application along with exemplary, non-exhaustive, and non-limiting manners and processes of making and using the inventions, in such full, clear, concise, and exact terms in order to enable skilled artisans to make and use the inventions without undue experimentation and sets forth the best mode contemplated by the inventors for carrying out the inventions.

In accordance with one or more arrangements of the disclosures contained herein, solution(s) are provided to improve systems, methods, and apparatus for managing and distributing files on servers and providing remote client access to the same. A reactive WebDAV read-only caching method can be used to provide on-demand content (e.g., files or directory search results) to clients. Immutable read-only files may be stored in a read-only caching file system in a read-only WebDAV server. The WebDAV functionality of the server can be as traditionally set forth in the industry standards. As such, existing and future client-side implementations of WebDAV will automatically and natively work with the disclosures of this invention. However, the server functionality and implementation will be modified in order to limit files to read-only files that the client cannot modify and to respond to pull requests as opposed to pushing files. And the files will be immutable such that they are never changed. By eliminating the possibility of editing the files or any metadata associated with the files, the WebDAV system is dramatically optimized. The read-only WebDAV server can receive, from a client, an on-demand file request for the immutable read-only file, and can reactively transmit the immutable read-only file to the client in response to the on-demand file request.

In some arrangements, the on-demand file requests and/or searches for files in a directory are made via HTTP. Files and directory search results may also be transmitted via HTTP.

In some arrangements, the read-only WebDAV service may reactively cache immutable read-only files on a cache server (if not previously cached thereto) in response to on-demand file requests by the client that return the files.

In some arrangements, the immutable read-only file can be reactively transmitted to the client by the read-only WebDAV if the immutable read-only file was not previously cached. Or, if the immutable read-only file was previously cached, it can be reactively transmitted to the client by the cache sever.

In some arrangements, the immutable read-only files or directories containing the same can be mounted by clients and can appear as though the files are locally available.

In some arrangements, clients may submit a file that has been modified (or whose metadata has changed) for direct or indirect updating in the WebDAV server. Any such modified file can be processed in order to make it read-only and immutable. Any such modified file does not modify the original file, since the original file and all files on the server are immutable. The modified file can be saved as a completely new file and will be read-only as well as immutable, just like the original file.

In some arrangements, cache invalidation control can also be provided to ensure that the cache contents are correct and are cleared if not.

In some arrangements, some or all of the various functionality and steps of this disclosure may be implemented as computer-executable instructions on non-transitory computer-readable media.

In some arrangements, a reactive WebDAV read-only caching method for providing on-demand content to a client can store, in a read-only caching file system in a WebDAV server, an immutable read-only file. The read-only WebDAV server can receive, from the client, an on-demand request for the immutable read-only file or for a directory listing of a file directory containing the immutable read-only file. In response to the on-demand request, the read-only WebDAV server can determine whether the immutable read-only file has been previously cached in a cache server. If the on-demand request was for the directory listing, the directory listing can be reactively transmitted from the read-only WebDAV server to the client. If the on-demand request was for the immutable read-only file (as opposed to a directory search), a cache server can reactively transmit the immutable read-only file if previously cached. If the file was not previously cached, the read-only WebDAV server can also send the file to the cache server so that it is cached for future use and requests. As noted previously, content is served reactively. So there is no proactive reading in response to a PROPFIND command, but cache warming as explained herein is within the scope of this disclosure and is allowed.

In some arrangements, a reactive WebDAV immutable read-only file system can include: a WebDAV server with a WebDAV processor, a WebDAV communication interface communicatively coupled to the WebDAV processor, and WebDAV memory communicatively coupled to the WebDAV communication interface. The WebDAV memory can store WebDAV computer-readable instructions that, when executed by the WebDAV processor, cause the WebDAV server to perform various functions. An immutable read-only file can be stored in a read-only caching file system. The WebDAV communication interface can receive, from the client, an on-demand request for the immutable read-only file or for a directory listing of a file directory, which might contain the file. File requests and transfers may be sent and received via HTTP. The immutable read-only file or the directory listing of the file directory containing the immutable read-only file can be reactively transmitted (if the immutable read-only file was not previously cached) from the WebDAV communication interface to the client in response to the on-demand request. If not previously cached, the immutable read-only file can be reactively cached.

In some arrangements, the reactive WebDAV immutable read-only file system may also include a cache server, which would similarly have a cache processor, a cache communication interface communicatively coupled to the cache processor, and cache memory communicatively coupled to the cache communication interface. The cache memory can store cache computer-readable instructions that, when executed by the cache processor, cause the cache server to perform various functions.

The immutable read-only file received via the cache communication interface from the WebDAV server interface can be cached in cache memory. If the immutable read-only file was previously cached, it may be reactively transmitted from the cache server to the client in response to the on-demand request. Caches may use both memory and/or disks. Hence cache memory can include both disk and memory storage.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 depicts a traditional Prior-Art WebDAV architecture and process for remote web content authoring and related operations.

FIG. 2 illustrates a sample operating environment and exemplary hardware/software components in which certain aspects of the present disclosure may be implemented.

FIG. 3 illustrates sample functionality and exemplary components that may be included in origin services or servers in which certain aspects of the present disclosure may be implemented.

FIG. 4 is an illustrative flow diagram of providing packages to clients for execution in which certain aspects of the present disclosure may be implemented.

FIG. 5 shows sample steps and functions that may be utilized in conjunction with the flow diagram configuration of FIG. 4. in which certain aspects of the present disclosure may be implemented.

FIG. 6 and FIG. 7 illustrate sample flow diagrams for implementing a WebDAV-based, read-only, caching, file system in which certain aspects of the present disclosure may be implemented.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized and structural and functional modifications may be made. It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable instructions can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (i.e., supervised, semi-supervised, reinforcement, and unsupervised), middleware, modules, objects, operating systems, processes, protocols, programs, scripts, tools, and utilities. The computer-executable instructions can be on tangible, computer-readable memory (local, in network-attached storage, remote, or cloud-based), can be stored in volatile or non-volatile memory, and can operate autonomously, on-demand, on a schedule, spontaneously, proactively, and/or reactively.

“Computers” can include one or more: general-purpose or special-purpose network-accessible administrative computers, clusters, computing devices, computing platforms, desktop computers, distributed systems, enterprise computers, laptop or notebook computers, controlling computers, nodes, personal computers, portable electronic devices, servers, controlled computers, smart devices, tablets, and/or workstations, which have one or more microprocessors or executors for executing or accessing the computer-executable software and data. References to computer machines, servers, clients, names of devices, etc. within this definition are used interchangeably in this specification and are not considered limiting or exclusive to only a specific type of device. Instead, references in this disclosure to computers and the like are to be interpreted broadly as understood by skilled artisans. Further, as used in this specification, computers also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing. A computer network includes any transport that supports HTTP.

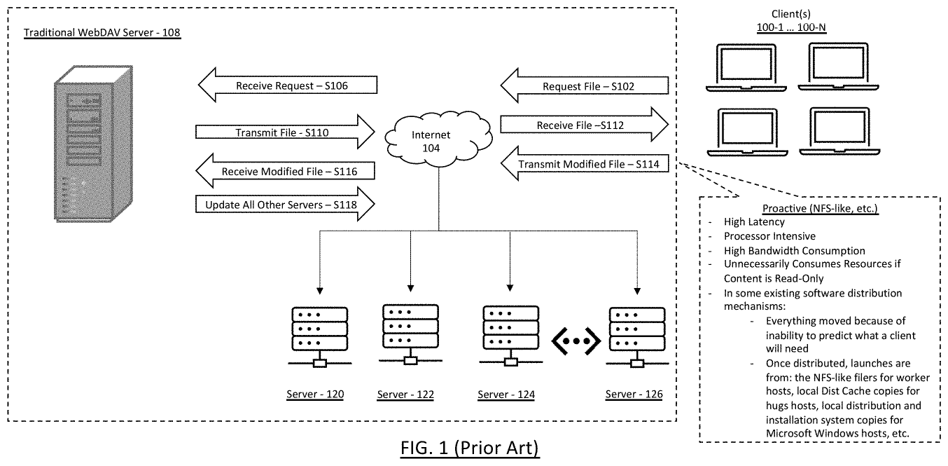

Prior-Art FIG. 1 illustrates a functional block diagram for a traditional WebDAV architecture. Various client devices 100-1 . . . 100-N can interact with a traditional WebDAV server 108 over a network or the Internet 104. Clients 100 can request files S102 from servers 108 that receive the requests S106. Clients 100 and Traditional servers 108 communicate using the WebDAV protocol as defined in RFC 4918. The traditional server 108 can transmit S110 requested files, which are received S112 by the client 100 that requested them. Clients can modify the files and then transmit S114 them to traditional servers 108 that will receive them S116 and replace the original file with the modified version thereof as part of a write operation. Clients are protected from “lost updates” by means of locks. The use of locks make the traditional use of WebDAV complex. Allowing content mutation on servers means that aggressive caching cannot safely be used. The use of locks and permitting mutable content makes this prior-art structure inefficient for large scale content distribution.

Traditional package distribution functionality is inefficient. It results in high latency, is processor intensive, consumes a large amount of bandwidth, and wastes significant network resources. Essentially, in traditional package distribution, everything is moved or copied proactively because of an inability of the system to predict what packages or parts of packages a client will need. Once distributed package components are lunched from local or near-local drives using physical discs or non-caching NFS services.

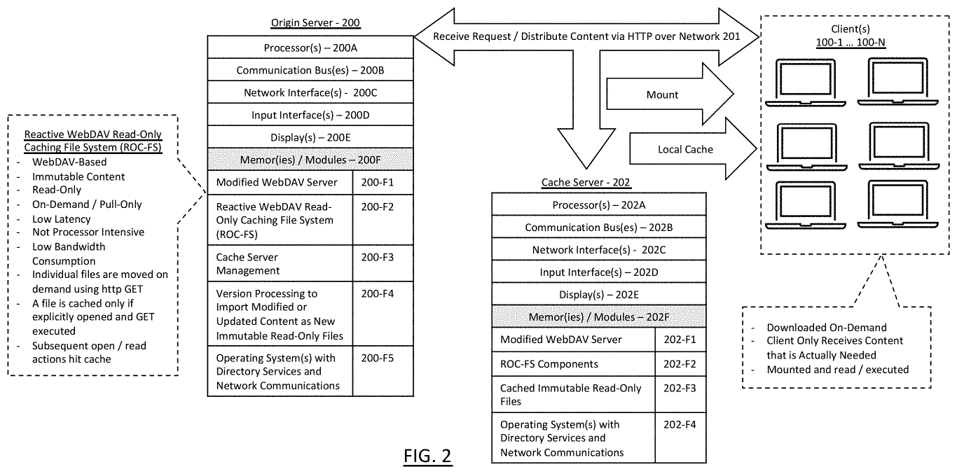

FIG. 2 illustrates a sample operating environment and exemplary hardware/software components in which certain aspects of the present disclosure may be implemented and includes various traditional client devices 100-1 . . . 100-N as well as one or more origin server(s) 200 and cache server(s) 202, which implement the improved WebDAV functionality described herein. The computer machines 200, 202 can include one or more processors 200A, 202A, one or more data or communication buses 200B, 202B, one or more wired or wireless network interfaces 200C, 202C, various input devices or interfaces 200D, 202D and displays 200E, 202E, as well as one or more memories that may contain various software or data modules 200F, 202F.

Memories/modules 200F, 202F may be volatile or non-volatile, and may include computer instructions, software, and/or data such as, for example, one or more program modules having instructions that when executed by processors 200A, 202A cause a computer machine, such as origin server 200 or cache server 202, to perform one or more functions described and/or one or more databases or other distributed file systems that may store and/or otherwise maintain information which may be used by such program modules and/or processor 200A, 202A. Sometimes, one or more program modules and/or databases may be stored by and/or maintained in different memory units of a computer machine and/or by different computing devices that may form and/or otherwise make up a collection of computer machines.

The memory or memories 200F for the origin server may include a modified WebDAV server module 200-F1 and an implementation of a reactive WebDAV read-only caching file system (ROC-FS) 200-F2. The memory 200F may also include a cache management module 200-F3 for monitoring and/or controlling cache server 202 such as, for example, to determine whether and when to reactively copy files to cache them in cache server memory 202F. This may also include a cache invalidation policy to ensure cached PROPFIND information is current. Barring a fault in the caching software, the file content of the cache will always be accurate. A cache may not have sufficient remaining space for new cache content to be added. In this case, the cache old content (least recently used) needs to be released to create room for more recent files. Origin server 200 may also have a version processing module 200-F4 to import modified or updated content as new immutable read-only files. Memories 200F may also include one or more operating systems 200-F5 with directory services that allow directory searches to be performed and file lists to be returned. The operating systems 200-F5 may also provide network communications functionality to enable communications or file transfers with other servers 202 and clients 100-1 . . . 100-N.

The key components of the ROC-FS are implementing the file system based on a modified version of WebDAV, requiring content to be immutable, locking files as read-only, and providing files to cache server 202 or clients 100-1 only on-demand via a “pull”. Individual files can be moved on demand using the HTTP GET command and can be cached the first time a file is requested or opened. Subsequent requests to open or read files can access the files from the cache.

Thus, remote hosts and clients can start off without any files in question. When files are needed (on-demand), the requested content can be pulled across the network. Only the content that is required is copied such as, for example, one at a time as needed. Or content could be copied or transferred in a parallel-downloader fashion (i.e., clients and caches can be asynchronous in nature and have many outstanding requests in play at any given time).

Traditionally, what makes WebDAV complicated is when users want to pull a file down, edit it or change it in some way, and then put it back, replacing the original content. The benefits of the inventions in this disclosure are that a standard protocol can be used (WebDAV) with existing client support, and implement a policy or ROC-FS so that only portions of the standard that are applicable for reading files are used. By never writing to files, intermediate caching and other related functionality can be implemented with the existing and currently available web standards.

The memory or memories 202F of cache server 202 can include similar modules as the origin server 200 such as a modified WebDAV server implementation if desired to serve cached copies of files to clients 100-1 . . . 100-N. One or more components of the ROC-FS 202-F3 may similarly implemented in whole or in part on cache server 202 in addition to or as an alternative to execution on origin server 200. Cached copies of the immutable read-only files may be stored in a cache memory, module, or data store 202-FC on the cache server 202. Cache server 202 may also have the same or similar type of operating system(s) with directory services and network communications 202-F4 as the origin server 200.

Since requested files (or files that are part of a directory search) are cached, they only need to be copied once (assuming caches of unlimited size). Once it has been copied either the cache server and/or the worker host has the file. Hence, the file only needs to move across the network once. And, unlike prior-art distribution systems which are proactive and copy everything in advance, the disclosed ROC-FS is reactive and, by default, does not need to do anything. If a machine never uses or requests a file, it is never copied or moved. Processor, bandwidth, and other machine or network resources are never wasted on files that are not needed.

The ROC-FS of various aspects of this disclosure can utilize multi-tier caching and can encompass three kinds of components. The first is a server, which hosts content that may be requested over HTTP. A server is reactive, responding to requests for content. The second is a client, which presents content as a filesystem on a target host and presents content to a user on demand. The third is a cache, which remembers content that has been requested by a client and served by a server. The flow of content is always from the server downstream to the client.

There are three kinds of cache. First is server cache, which exists on the same host as a server to accelerate the service. It is sometimes called a reverse-proxy cache. The second is client cache, which exists on the same host as a client to largely eliminate network I/O when re-reading content. The third is intermediate cache, which exists on a distinct host, acting as a server to downstream components and a client to upstream components. The downstream flow of an item of content will always start in response to a request received by a server. The content will then flow through an arbitrary number of caches until it reaches the server.

Multi-tier caching is the process of introducing intermediate caches in support of regions, countries, cities, data centers, and potentially even racks. A multi-tiered approach brings items locally and physically closer to the users and minimizes network usage.

Cache warming may be used in various aspects of this disclosure. Cache warming is a technique which may be used with a mounted filesystem instance to warm caches in anticipation of a particular usage. In practice, this may mean running a test job which causes all required files for an actual job (i.e., a real job) to be downloaded. For example, if a production job was to run in the morning and had to run at 09:00 a.m. and run as quickly as possible, a cache warming job could be run at 08:30 a.m. causing all needed files to be present in the cache so when the real job started there would be no network delay.

There are two distinct kinds of content involved with a ROC-FS. First, files are obtained using an HTTP GET command. Second, file and directory information is obtained using an HTTP PROPFIND command.

Files are immutable, so with a sufficiently large cache no discards would ever be required. If desired, caches could be limited in size in which case it would be necessary to remove items from the cache to make room for newly requested items. Items could be removed on a least recently used (LRU) basis. Cache sizes can be selected based on a balance of costs with the main factor likely being the cost of storage vs. required performance. Additionally, caches should be sized to accommodate the largest individual file to be handled by a given client and upstream caches. Otherwise, requests for files that are too big for the intervening caches will fail.

The content of folders in a ROC-FS can change. This will happen when new content is added to the origin service. PROPFIND responses will be cached with a TTL (time to live). New content added to the origin server will only become visible to a client when any PROPFIND documents for the containing folder have expired. A server may add a TTL value to PROPFIND XML documents so caches and clients know how long to retain PROPFIND results. It would be possible, even desirable, to be able to have a default TTL and the ability to override this in the server configuration because some folders (e.g., those within a released package) may be very stable while others (e.g., the folders containing versions of releases) may change more often.

A client may know, because of configuration data, that a new release is available but the new release may not be visible in the ROC-FS, perhaps because PROPFIND responses are cached and thus new content is not yet visible. It would be possible to add functionality to a ROC-FS client and intermediate caches instructing them to drop part or all of their cached data, most usefully cached PROPFIND responses (since everything else is guaranteed to be immutable). Clearing caches in this way is sometimes known as cache busting or referred to as blowing a cache. It is possible to introduce a control channel to caches and clients within a ROC-FS such as, for example, using the Simple Network Management Protocol (SNMP), such that caches could be busted or blown remotely. Remote cache busting could be a useful and powerful support tool for use with a ROC-FS.

A cache index by hash is an additional aspect of the disclosure which further improves efficiency. In particular, there are a surprisingly large number of duplicated identical files in a typical package folder/file hierarchy. For example, the _init_.py file appears for every package folder from which Python code may be imported, and these files are typically empty, because the presence of the file is a marker. There are other examples where quite large files are duplicated.

The WebDAV protocol allows a server to include arbitrary information in a PROPFIND response document. When composing the XML document in response to a PROPFIND request, the server could include the hash of each file. A client or cache could then index its cached content by hash and map file path names to hashes. For example, this could mean that all _init_.py files could appear to be present to a client filesystem where in the cache there was only a single copy of the file. Any attempt to read a file could include the step of determining what is the hash of the file as given in the PROPFIND XML document. A determination could then be made as to whether a file in the cache for the hash exists. If so, the path of the newly requested file could be mapped to the existing hash. This would obviate the need for a GET requests or consuming more space in the cache.

Since a ROC-FS is using HTTP, a person of skill in the art will understand that security can be implemented using HTTPS. This would involve secure connections being made between each element of a ROC-FS, so from client to caches, to other cache, to origin server. Each connection between components can be individually secured.

Boosting containers may also be used. A read-only caching network file system can boost the effectiveness of containers such as Docker. When building a container, the content to be included therein may be sourced from a ROC-FS. When distributing a container, a ROC-FS can be used to distribute containers on demand since to use a container it must be made available on the executing host. By making containers smaller, content which is unique to a container must be included in the container, but much content is common and used across many containers. If the common content were included in every container that needed it, then there would be much duplication and each container would be “fat.” If instead a container mounts a ROC-FS to get access to common content, then the container can be “thin,” which is more efficient.

By using standards-based protocols as contemplated herein, the operational function of a ROC-FS can be monitored and examined in detail. A detailed understanding of what content is used where and by whom could be constructed. Information about usage could inform the optimal configuration of caches and other system components.

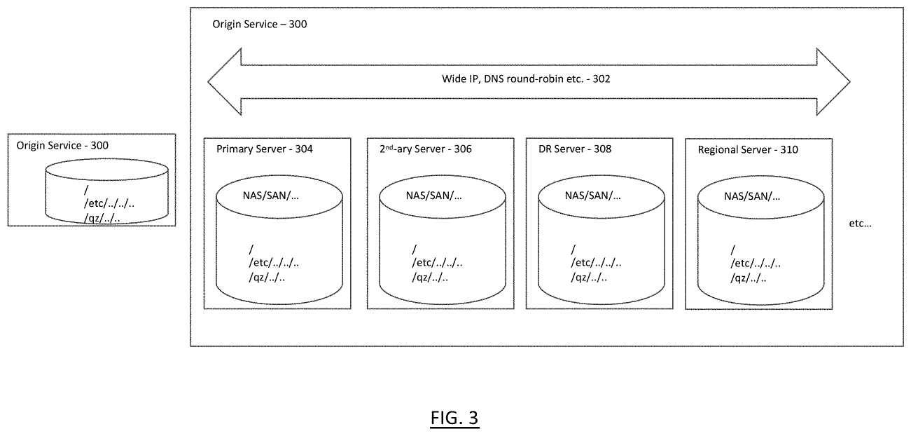

Referring to FIG. 3, the origin server 200 may be a standalone computer machine or comprise an origin service 300 with distributed functionality 302 via wide IP, DNS, round-robin, etc. across one or more other compute machines such as a primary server 304, a secondary server 206, a DR server 308, a regional server 310, or the like.

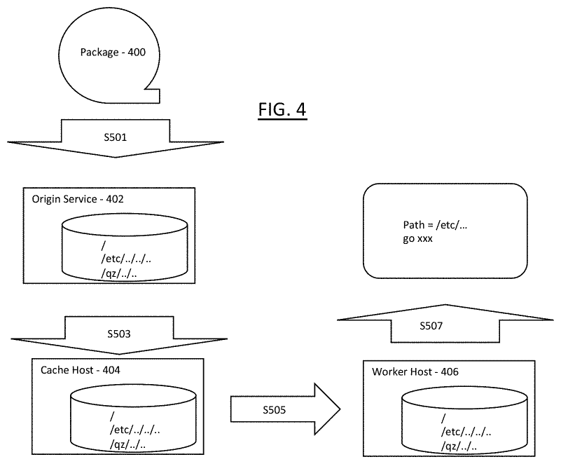

Referring to FIG. 4, a package 400 may be built (i.e., the executables and associated content can be created and published). An origin service 402 can make the package components available to cache servers 404, worker hosts 406, or clients, directly or indirectly, by distributing (i.e., moving the contents around the network or over the Internet as needed). Files and executables can be mounted. And package components (e.g., files, executables, etc.) can appear as installed locally on clients or worker hosts, directories can be listed, and files can be read or executed as if on a local disk. Executables may be launched or files may be read.

The ROC-FS distributes whatever content has been added to the origin server. For software packages, the content added to the original server is the unpacked content of the package, which is what a user would see if the package was installed on a standalone computer. Once mounted, a ROC-FS allows a user to execute the program and proceed as soon as the environment variables are set.

All package components (files) preferably look as if they are installed locally. On the worker host or client, the directories can be listed (ls or dir), the files can be read (less or cat) or executed just as if they are on a local disk drive.

When building containers the required package versions can be copied to the container from the ROC-FS. Within the container the environment variables to use the copied package versions can be set. Regarding moving the container to the host that will be running it, the container can be copied to the ROC-FS origin server to make it immediately available to all worker hosts, or the container can be copied to a specific worker host, cloud service, etc.

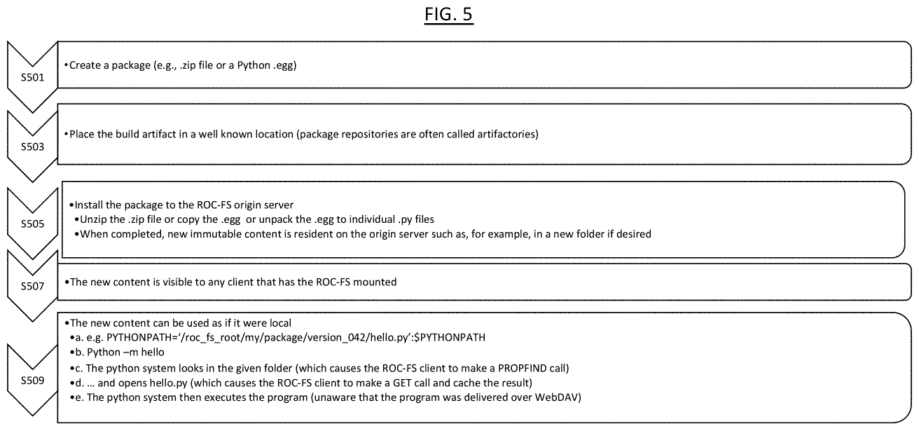

Referring to FIG. 5, a package such as a .zip file or a Python .egg is created in S501. The built artifact is placed in a well-known location in S503. In this context, a person of skill in the art would understand that package repositories are often called artifactories. In S505, the package is installed to the ROC-FS origin server. The .zip file is unzipped, or the .egg file is copied, or the .egg file is unpacked into individual .py files. When completed, new immutable content is resident on the origin server such as, for example, in a new folder if desired. In S507, the new content is then visible to any client that has the ROC-FS mounted. In S509, the new content can be used as if it were local.

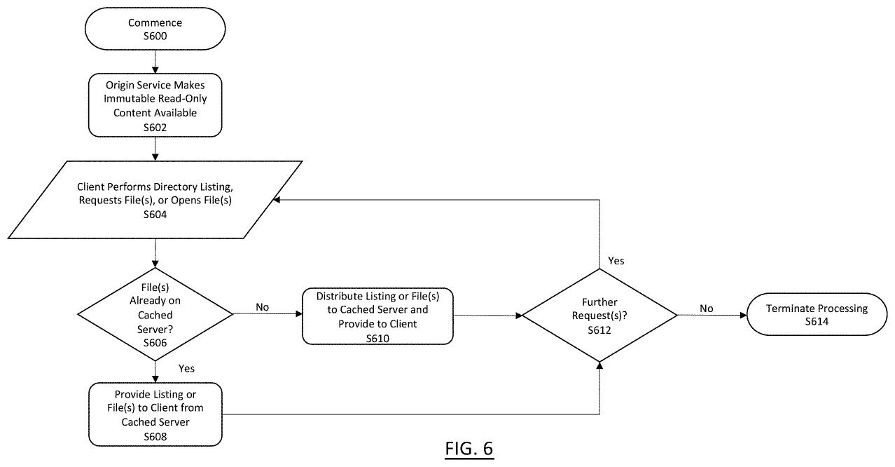

FIG. 6 illustrates a sample flow diagram for implementing a WebDAV-based, read-only, caching, file system. After commencement S600, an origin service can make immutable read-only content available S602. A client can perform a directory search (i.e., request a directory listing), request files, execute files, or open files S604. A determination can be made as to whether the requested file (or the files included with the results of a directory search or listing) are already on the cache server S606. If they have not already been cached, they can be copied or transferred to the cache server S610 and also provided directly from the origin service to the client. If they have been cached, they can be copied or transferred from the cache server to the client S608. The ROC-FS can then wait S612 to see if there are any other file or directory request. If not, the process can be terminated S614.

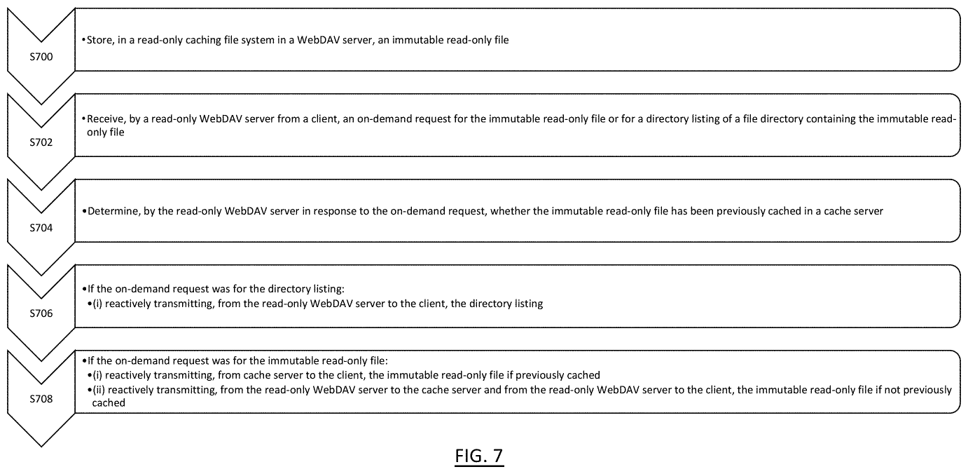

FIG. 7 illustrates another sample flow diagram for implementing a WebDAV-based, read-only, caching, file system. In S700, an origin service can store an immutable read-only file in a read-only caching file system as part of a WebDAV server implementation. An on-demand request for the immutable read-only file or for a directory listing of a file directory containing the immutable read-only file can be received by a read-only WebDAV server from a client S702. A determination can be made, by the read-only WebDAV server in response to the on-demand request, whether the immutable read-only file has been previously cached in a cache server S704. If the on-demand request was for the directory the directory listing can be reactively transmitted, from the read-only WebDAV server to the client. As in S708, if the on-demand request was for the immutable read-only file, the immutable read-only file can be reactively transmitted, from cache server to the client, if previously cached, and the immutable read-only file can be reactively transmitted, from the read-only WebDAV server to the cache server and from the read-only WebDAV server to the client, if not previously cached.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1) A reactive WebDAV read-only caching method for providing on-demand content to a client comprising the steps of:
a) storing, in a read-only caching file system in a read-only WebDAV server, an immutable read-only file;
b) receiving, by the read-only WebDAV server from the client, an on-demand file request for said immutable read-only file; and
c) reactively transmitting said immutable read-only file to the client in response to the on-demand file request.

2) The reactive WebDAV read-only caching method of claim 1 wherein the on-demand file request is received via a hypertext transfer protocol.

3) The reactive WebDAV read-only caching method of claim 2 wherein said immutable read-only file is transmitted via the hypertext transfer protocol.

4) The reactive WebDAV read-only caching method of claim 3 further comprising the step of reactively caching, by the read-only WebDAV server in a cache server in response to the on-demand file request, the immutable read-only file if not previously cached.

5) The reactive WebDAV read-only caching method of claim 4 where the immutable read-only file is reactively transmitted to the client by the read-only WebDAV server if the immutable read-only file was not previously cached by the client and is reactively transmitted to the client by the cache sever if the immutable read-only file was previously cached there.

6) The reactive WebDAV read-only caching method of claim 5 further comprising the step of receiving, by the read-only WebDAV server from the client, an on-demand directory listing request for a file directory that contains said immutable read-only file.

7) The reactive WebDAV read-only caching method of claim 6 further comprising the step of reactively caching, by the read-only WebDAV server in the cache server in response to the on-demand directory listing request, a directory listing response if not previously cached.

8) The reactive WebDAV read-only caching method of claim 7 in which the steps are implemented as computer-executable instructions on computer-readable media.

9) The reactive WebDAV read-only caching method of claim 7 in which the WebDAV server steps are implemented as WebDAV computer-executable instructions on WebDAV computer-readable media and in which the cache server steps are implemented as cached-server computer-executable instructions on cached-server computer-readable media.

10) The reactive WebDAV read-only caching method of claim 9 in which said immutable read-only file appears to the client as being locally stored but is remotely stored on either the read-only WebDAV server or the cache server.

11) The reactive WebDAV read-only caching method of claim 10 further comprising the step of: separately storing, by the WebDAV server in the read-only caching file system in response to receipt from the client of a modified version of the immutable read-only file, a new immutable read-only version of the immutable read-only file, such that the immutable read-only file is not modified.

12) A reactive WebDAV read-only caching method for providing on-demand content to a client comprising the steps of:
a) storing, in a read-only caching file system in a WebDAV server, an immutable read-only file;
b) receiving, by the read-only WebDAV server from the client, an on-demand request for said immutable read-only file or for a directory listing of a file directory containing said immutable read-only file;
c) determining, by the read-only WebDAV server in response to the on-demand request, whether said immutable read-only file has been previously cached in a cache server;
d) reactively transmitting, from the read-only WebDAV server to the client, said directory listing if the on-demand request was for said directory listing;
e) if the on-demand request was for said immutable read-only file:
f) reactively transmitting, from cache server to the client, said immutable read-only file if previously cached; and
i) reactively transmitting, from the read-only WebDAV server to the cache server and from the read-only WebDAV server to the client, said immutable read-only file if not previously cached.

13) The reactive WebDAV read-only caching method of claim 12 wherein the on-demand request is received via a hypertext transfer protocol.

14) The reactive WebDAV read-only caching method of claim 13 wherein the immutable read-only file is transmitted via the hypertext transfer protocol.

15) The reactive WebDAV read-only caching method of claim 14 in which the steps are implemented as computer-executable instructions on computer-readable media.

16) The reactive WebDAV read-only caching method of claim 14 in which the WebDAV server steps are implemented as WebDAV computer-executable instructions on WebDAV computer-readable media and in which the cache server steps are implemented as cached-server computer-executable instructions on cached-server computer-readable media.

17) The reactive WebDAV read-only caching method of claim 16 in which said immutable read-only file appears to the client as being locally stored but is remotely stored on either the read-only WebDAV server or the cache server.

18) The reactive WebDAV read-only caching method of claim 10 further comprising the step of: separately storing, by the WebDAV server in the read-only caching file system in response to receipt from the client of a modified version of the immutable read-only file, a new immutable read-only version of the immutable read-only file, such that the immutable read-only file is not modified.

19) A reactive WebDAV immutable read-only file system comprising:
a WebDAV server having:
i) a WebDAV processor,
ii) a WebDAV communication interface communicatively coupled to the WebDAV processor;
iii) WebDAV memory communicatively coupled to the WebDAV communication interface, said WebDAV memory storing WebDAV computer-readable instructions that, when executed by the WebDAV processor, cause the WebDAV server to:
(1) store, in a read-only caching file system, an immutable read-only file;
(2) receive, by the WebDAV communication interface from the client, an on-demand request for said immutable read-only file or for a directory listing of a file directory, said on-demand request being received via a hypertext transfer protocol;
(3) reactively transmit, via said hypertext transfer protocol from the WebDAV communication interface to the client in response to the on-demand request, the immutable read-only file or the directory listing of the file directory containing the immutable read-only file if the immutable read-only file was not previously cached; and
(4) reactively cache, via the WebDAV communication interface in response to the on-demand request, said immutable read-only file if not previously cached.

20) The reactive WebDAV immutable read-only file system of claim 19 further comprising:
a cache server having:
i) a cache processor,
ii) a cache communication interface communicatively coupled to the cache processor;
iii) cache memory communicatively coupled to the cache communication interface, said cache memory storing cache computer-readable instructions that, when executed by the cache processor, cause the cache server to:
(1) cache, in said cache memory, the immutable read-only file received via the cache communication interface from the WebDAV server interface; and
(2) reactively transmit, via said hypertext transfer protocol from the cache communication interface to the client in response to the on-demand request, the immutable read-only file if the immutable read-only file was previously cached.
